(19) United States
(12) Patent Application Publication
(10) Pub. No.: US 2004/0004456 A1
(43) Pub. Date: Jan. 8, 2004

(54) Automatic control equipment for cleaning a plate surface exhibiting varied soiled conditions , and use method

(76) Inventors: Loan My LeBa, Rochseter Hills, MI (US); Vladimirs Nikulenkovs, Riga (LV); Karlis Freivalds, Riga (LV)

Correspondence Address: Andrew R Basile, Young & Basile, Suite 624, 3001 West Big Beaver Road, Troy, MI, 48084, US

(21) Appl. No.: 10/312,100

(22) PCT Filed: Jun. 19, 2001
(86) PCT No.: PCT/FR01/01910

(30) Foreign Application Priority Data
Jun. 22, 2000 (FR) 00/07991

(51) Int. Cl. H02P 1/04

(52) U.S. Cl. 318/482

(57) ABSTRACT

The invention concerns an equipment for cleaning a motor vehicle windshield comprising at least a light source (1), an opaque stain channel, an aqueous stain channel and at least an optical detector (2b) of ambient light, each stain channel comprising at least an optical detector (2) with independent photosensitive element, the source (1) and the optical detectors (2) being arranged on a support on the side of the inner surface (10a) of the windshield (10) to be cleaned. The optical detectors (2) are at a distance from the source (1) based on backscatter angles (C, D) of the opaque stains and reflection (A, B) of the aqueous stains. An electronic processing unit (4) comprising a multiplexing block (3) and a microcontroller (5), is coupled in input with the optical detector channels, and in output with a control unit (6) for the wiper and windshield washer of the surface (10b) to be cleaned.

### BACKGROUND

The invention concerns an automatic control equipment for cleaning a plate surface exhibiting varied soiled conditions, as well as the use method of such equipment.

This invention relates to the domain of automobile cleaning and washing systems, as well as the control and automation management of such surface automation, in particular, the clean conditions of windows and windshields of vehicle systems.

It is already known in U.S. Pat. No. 5,703,568, a system for detecting drops of water that uses a light-emitting diode (LED) and an optical detector, placed behind a panel pierced with openings, of such a type that the pulsed light emitted by the LED is not directly detected by the optical detector, but only via backscatter on the windshield or via the presence of particles, such as smoke, in the cabin. After subtracting the ambient light from the signal, the signal received by the optical detector furnishes, after amplification and averaging, a rain signal to a control microprocessor for the wipers. This system only allows detection of rain and for only one angle of given backscatter.

However, a wiper regulator exists such as described in patent JP 05-5698. This regulator comprises a light source and an optical detector placed near the windshield, a first and second comparison, an operational block and a transmission block to the wiper command system. This regulator registers the quantity of light flux that traverses the windshield and compares the signal exiting from the optical detector to a standard signal. In the case where the optical detector exit signal stays, for a sufficient time, lower than the standard signal, the wiper control system is begun.

Such a regulator only allows detection of the presence of water and does not furnish any information on the degree of stains on the surface to be cleaned. In addition, its installation is complex.

Known devices don't allow detection in a sufficiently sensitive manner for different climatic phenomenon—rain, freezing rain, hail, snow, mud, dry or wet dust, salt, static staining film or all types of stains—which can follow one another or combine over time, in order to begin the cleaning best adapted to the surface to the cleaned.

The invention aims, on the contrary, to furnish such an adaptation with an increased level of performance, by optimizing at every moment the cleaning speed to the type and degree of staining on the surface to be cleaned, and by integrating in the identification time of the nature and the intensity of the stains.

### SUMMARY

In order to achieve this goal, it is proposed to detect the state of the cleanliness of the surface to be surveyed via detections more specifically angular, dedicated more specifically to one stain type, opaque or aqueous, such as via detection of the ambient light, then electronically processing, and then comparatively analyzing these detections.

More precisely, the goal of the invention is the automatic command equipment for cleaning a plate surface exhibiting varied soiled conditions, comprising a light source, an opaque stain channel, an aqueous stain channel and at least an optical detector of ambient light. Each stain channel comprising at least an optical detector with independent photosensitive element. The source and the optical detectors being arranged on a support on the side of the inner surface of the plate to be cleaned and the optical detectors are at a distance from the source based on backscatter angles of the opaque stains and on the reflection of the aqueous stains. An electronic processing unit, comprising a multiplexing block and a microcontroller, is coupled in input with the optical detector canals and in output with a control unit for the wiper and windshield washer of the surface to be cleaned.

In the specific production shapes:

the photo sensitive surface of each optical detector is equipped with an infrared optical filter and each source emits infrared light; or each optical detector is coupled to a band pass filter, for example, with thin layers or with interferential network, and each source emits a light into the band pass of the filter, in visible or infrared light;

the light source is a diode, which emits in the spectrum of infrared or visible, and is surrounded by a guiding mask of the emitted light;

the aqueous stain optical detectors are arranged at the points of a polygon, the emitting source of which is arranged in the polygon; or

the optical detectors and the emitting source or sources are attached to a printed circuit support, for example in epoxy, arranged opposite from the internal surface of the plate to survey.

In the present description, the term plate refers indiscriminately to the windshield, the window or modulated light envelopes of a motor vehicle. A drive is said to be comfortable when it is possible to reestablish correct vision or lighting across the plate surface, during a time shorter than a determined safe duration, and when erratic speed changes or changes not related to the circumstances can be avoided.

The invention is not limited to optical detection; it is possible to use another type of detection, for example ultrasonic, capacitive, electromagnetic, etc.

The invention also has as a goal a process for controlling the cleaning of a plate surface, specifically a motor vehicle window, via optical detection dynamic in response to its condition, the plate having a depth limited by the surface to be cleaned and an internal surface, in which at least a modulated light flux is emitted across the width of the plate then backscattered and/or back-reflected by the surface to be cleaned, the light intensity of the light module being then measured in several elementary sensitivity zones in the form of level amplitude of signals successively transmitted across the opaque and aqueous stain detection channels via the equipment use method of the invention.

The levels of each detection zone channel, as well as that of the ambient light, are successively cumulated in a time interval given in order to form samples to be recorded. In a detection algorithm, the relative spread between first, the value of the current samples of each detection of each channel and, secondly, the sample values of the same detection memorized in a short term and, respectively, at least a floating reference, being able to be lower values, are determined in relation to the values of the current samples in order to form, respectively, two different deviations. At least one of these deviations is compared to at least one predetermined threshold.

The functioning systems for the wiper blades are defined by the speed of the wiping cycles, classically defined: fixed stop (no speed), periodic intermittent wiping (low speed), slow wiping (medium speed), fast wiping (high speed); and for washing, the number of wiping cycles during which the liquid is projected onto the plate, for example two to five wiping cycles.

A cleaning system adapted to the number, to the stain channel type and the duration of the detections for which the deviations are greater than the values of the predetermined thresholds, is thus required.

In a specifically preferable use method of the control process conforming to the specifications of the invention, the measure of the level of ambient light being performed and being recorded at the same speed as that of the measures of the levels of modulated light in each channel, the results of the comparisons of the absolute vales of the spreads relative to the modulated light are only taken into account if the variation of the level of ambient light at the same instant is lower than a determined threshold. The measure of the level of ambient light thus permits validation of the current detection signals and thus of the observed deviations. Preferably, at least four signals are read by the channel and are validated via the measure of the level of ambient light.

In a preferred method, the aqueous stain detection is a function of the condition of the functioning wipers;

when the wipers are resting, the detection is registered if the detected level in the channel surpasses the reference value of a value higher that a predetermined threshold value;

when the wipers are functioning, the detection is taken into account at the end of working cycle if the minimum number concerning the cleaning period is greater than two.

Preferably, the detection of an opaque stain, such as dust, salt or insect remains, is accessible from:

the aqueous stain channel, if the level of detection is greater than a reference value surpassing a predetermined threshold value, when such a spread is found to be at least over a predetermined number of cycles of a detection or for a predetermined number of detections; and

the opaque stain channel, when the level is greater than a predetermined threshold value, the stains accumulating slowly being more specifically detected by the channel; in order to avoid a useless cleaning, for example in the case of a snowfall, it is verified that the stain stays after at least one passage of the wipers.

According to a production example, the absolute values of the spreads relative to the short term and/or a longer term between the samples at the level of modulated light are compared to at least one predetermined threshold, the short term spread being determined between the current sample and a previous sample closer in time, for example, the sample immediately previous, and the long term spread being determined between the current sample and a previous sample further away in time.

According to other production examples, the absolute values of the relative spreads are determined between, first, the current sample and, secondly, a previous sample closer in time and respectively a floating reference value. A level of constant current signal on a number of predetermined samples, the consistency of which is periodically verified and re-updated, can preferably be made up of a floating reference level.

In a production mode of the detection algorithm, the measures of the modulated light performed are treated in an algorithm with four branches corresponding to the phases or events following a wiping cycle:

a “resting” phase, during which the absolute values of the spreads between the samples of modulated light are determined with the aid of one of the preceding examples of determination;

a “beginning cycle” wiping event, or a minimum counter reset to zero;

a “work” phase, during which the minimums are researched on each channel, by recording the lowest level of modulated light found at a given instant and by measuring an increase of the current level, in relation to the memorized level, greater than a predetermined value, by reinitializing the memorized level at this current level, then by *incrementing a minimum counter; and

an “end of cycle” wiping event, or the minimum number, greater than two, found for a given channel during the work phase is compared to a predetermined threshold, in the case where the minimum number surpasses the threshold, a presence of water is identified on the channel and the number of detections or the presence of a stain is identified is thus augmented by one unit; this number determining the wiping system required from this instant on. The two minimums necessarily detected coming from the wipers themselves.

According to variances, the determination of the absolute values of the spreads between the samples of modulated light with the aid of one of the preceding determination examples also takes place during the work phase.

According to a decisional algorithm production method, the wiping mode is chosen as a function of the elaborate request via the detection algorithm, and based on the data relative to the current speed via an analysis of the cumulative history over a given period of the number of zones having identified a stain, opaque or aqueous, in order to control the transitions from the current cleaning mode to the requested mode when the required cleaning mode corresponds to a different wiping speed, for example lower. The chosen speed is thus the most appropriate for the comfort of driving via application based on the current speed.

### BRIEF DESCRIPTION OF THE DRAWING

Other characteristics and advantages of the invention will appear in the reading of the detailed description that follows and which relates to the production examples illustrated by the attached figures representing respectively:

FIG. 1 is a lateral cut view of an example of an automatic control equipment for cleaning according to the invention; and

FIG. 2 is an example of a detection and decision cleaning control algorithm.

### DETAILED DESCRIPTION

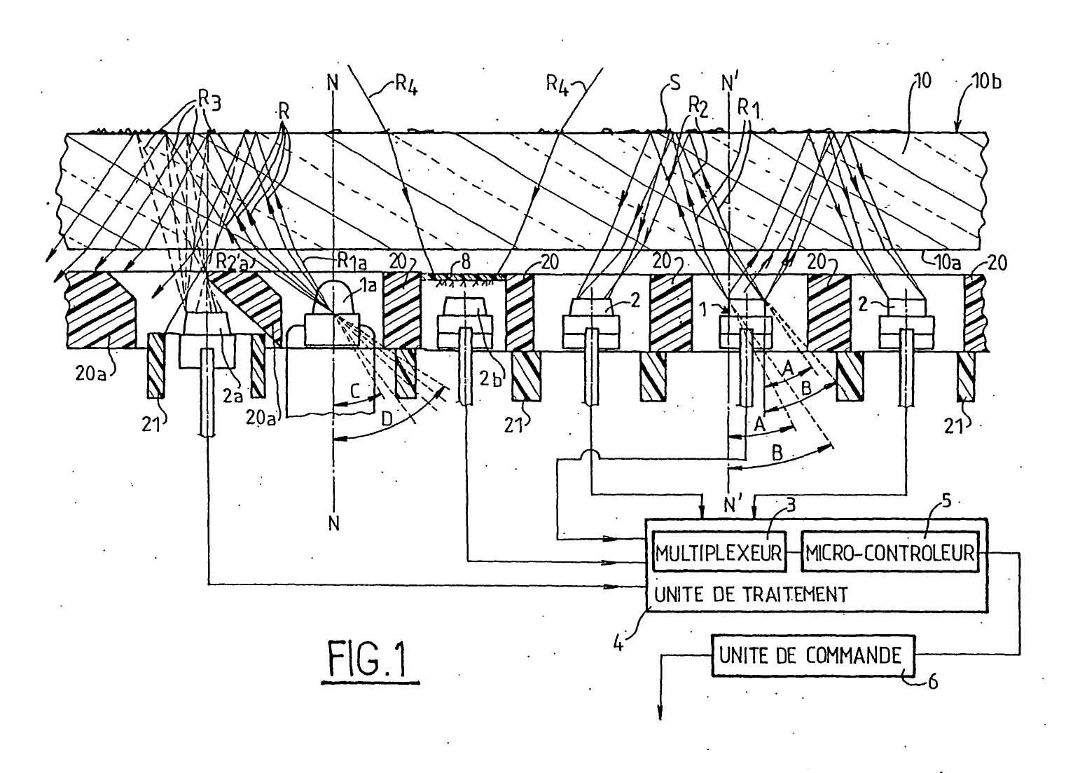

In reference to the lateral view of FIG. 1, equipment according to the invention comprises electroluminescent light sources LED 1 and 1a, three in the production example, and infrared optical detectors 2, numbering two groups of four in the example, at the tops of two squares in the plane perpendicular to that of FIG. 1, only one group being represented, and a ninth optical detector 2a of opaque stains. The masks 20, 20a optically isolate the LED's and the optical detectors from each other, the LED's and optical detectors being mounted on the brace 21,2.

The optical detectors are linked to the entry of a multiplexing block 3 of an electronic processing unit 4 comprising a microprocessor and a microcontroller 5, the microcontroller 5 being linked to a wiping and washing system 6 of the windshield 10 of a vehicle.

The equipment is arranged in the cleaned zone. This zone is completed by a resting zone situated around the stopped position of the blade and in which the wiping cycle is said to be “resting”. In movement, this phase begins just after the “end of cycle” event, located for example by a position sensor, and ending just before the “beginning cycle” event, separated from the end of cycle event by an interval of predetermined time or determined by the position sensor. In absence of movement, this phase corresponds to the stopped position.

Following the type of wiping: parallel, antagonist or linear, the equipment is arranged in an adapted strategic placement, in particular, in a high position (central, left or right) in the case of a windshield.

In operation, a modulated light flux is emitted via each source 1 and guided by masks 20 in the direction of the internal face 10a of the windshield 10, the external face 10b of which is to be surveyed. The distance between each aqueous stain LED and the surrounding optical detectors 2 and the dimensions of the masks are determined, as a function of the sides of the optical components and the width of the windshield, in order to correspond to the back-reflected angles of the light trajectory, limited by the masks 20, included between the end rays R1 and R2. These R1 and R2 rays form with the normal N′N of the windshield the angles A and B, respectively, included between approximately 25 and 40 degrees.

The light reflected by the external face 10b at the level of each detection zone, carrier or not of stains S, is received independently by each photosensitive face of the optical detectors 2. The acquisition time of the level of modulated light on each zone is around 1 ms. In a production variance, the equipment functions with visible light and the optical detectors are coupled to the interferential network filters.

The distance between the LED la, dedicated to opaque stain detection, and the surrounding optical detector 2a, as well as the dimensions of the mask 20a, are determined, based on the sides of the optical components and the depth of the windshield, in order to form rays R3 backscattered from the rays R by the external face 10b, such as those represented by dotted lines. These rays are issued from an incidental beam comprised between some end rays R1a and R2a, which form with the normal N′N of the windshield, the emission angles C and D respectively comprised between around 30 and 55 degrees before refraction on the internal face 10a of the windshield, and between around 35 and 60 degrees after refraction on this face.

The optical detectors 2 are linked to the multiplexing block in order to form a channel dedicated more specifically, but not exclusively, to the detection of aqueous stains, and the optical detector 2a forms the channel of the opaque stains.

Each optical detector furnishes to the multiplexing block 3 an electric signal of amplitude proportional to the modulated light flux received by the optical detection zone. The multiplexing block 3 successively selects the signals simultaneously received by the optical detectors in order to furnish a signal representing each detection. The signals are treated via synchronous demodulation and amplification in order to be converted to the level of tension corresponding to the amplitude of the modulated light flux coming from each detection zone. The processing unit 4 is of the converter type known in the trade.

These elementary levels are applied to the microcontroller 5 that chooses the optimal functioning system of the cleaning device 6, based on the detection and decision algorithms, an example of which is described hereafter, by a microprocessor associated with the sampling, memorization, and comparison means integrated into the microcontroller. The control process is used from the data coming from the block 4 and the data during the cleaning cycle phase furnished by the device 6. The microcontroller also regulates the control of light sources via the intermediary of the processing unit 4 in order to modulate the intensity of the sources.

In the specific production illustrated example, a supplementary optical detector 2b is created in order to form an ambient light channel from a signal representative of ambient light. The ambient light coming from a solid angle limited by the rays R4 is diffused across a diffusing translucent film 8, and captured by the optical detector 2b, which applies a level value to the microcontroller via amplification of the signal operated by the electronic processing unit 4.

According to the control process of the invention, the following steps take place.

The modulated light reflected or diffused by the surface to be cleaned, then detected in each stain detection zone (i), is represented at the current instant “n” via an assembly of the level of sampled amplitude Aₙ(1), Aₙ (2), . . . , Aₙ(i), each sample itself being the cumulative result in the microcontroller of a determined number of successive elementary values of the level, of two values in the production example. In other examples, this number can also be equal to 3 or 4, and the values of the elementary levels can be cumulated or averaged.

In the use example, each current amplitude sample Aₙ(i) of each zone (i) is compared in relative value to the last registered sample Aₙ₋₁(i) at the moment of the preceding recording (n−1) and at the sample registered previous to that Aₙ₋ₘ(i) at the moment of recording n−m, typically several seconds beforehand for m=3 in the production example, according to the different following deviations (1) and (2), expressed in percentages:

Δₙ(i)=(Aₙ(i)−Aₙ−(i))/Aₙ(i) (1)

Δ′ₙ(i)=(Aₙ(i)−Aₙ₋ₘ(i))/Aₙ(i), with n>m≧2 (2)

The primary deviation Δₙ(i) allows determination of the type of stain on the face to be surveyed at the moment of recording the current amplitude level, aqueous stains, such as drops of water, melted snow, or opaque stains, such as snow or insects remains.

The secondary deviation Δ′ₙ(i) allows following the appearance of stains by slow dynamic evolution, for example, droplets of water or, more specifically, stains opaque upon formation, such as mud or a layer of dust. These deviations are taken into account by the algorithms described hereinafter.

In addition, the sample of the amplitude of the ambient light is recorded at every instant in the microcontroller. Its relative variation Δ0ₙ is determined from the current level of amplitude A0ₙ and from the last recorded level of amplitude A0ₙ₋₁ from the following relationship:

Δ0ₙ=(A0ₙ−A0ₙ₋₁)/Aₙ (3)

The samples of the signals coming from the modulated light channels are ignored when the relative variation Δ0ₙ(i) is greater than a ceiling variation value of ambient light ΔA, also taken at 10% in the production example. Taking into account this relative variation allows better elimination of the disturbance of the control of the cleaning device, for example an untimely activation of wiping, linked to periodic or random variations of ambient light. These disturbances appear, for example, by driving the car on a road lined with trees, or passing through a tunnel.

The determinations are simultaneously performed for each optical detector zone, and cyclically, at a fast speed of 14 ms in the production example, of the type that the condition of each channel is continuously analyzed. The analysis is based on the comparisons of the following data:

if the absolute values of the deviations are lower than or equal to, respectively, the threshold values, no stain is registered as having appeared on the surveyed surface;

if the absolute values of the deviations are greater than the these threshold values for at least one of the eight zones of the aqueous stain channel, a stain of rain, melted snow, ice or snow is recorded as present on this face;

an opaque stain is recorded if the deviations are greater than the threshold values, for at least two zones of the aqueous zone channels or for more than three measuring cycles;

if the absolute value of the secondary deviation of the opaque stain channel, is greater than the value of the predetermined threshold during a duration greater than a wiping cycle of the wipers, an opaque stain accumulating slowly being detected by this channel.

the type and degree of the stain in the identified type are determined by the number of zones the absolute values of the deviations of which Δₙ(i) and Δ′ₙ(i) are recorded as respectively greater than the values of the threshold of the corresponding stain;

a function of the type and degree of stain thus determined, a functioning speed of the cleaning device in order to eliminate this stain is activated.

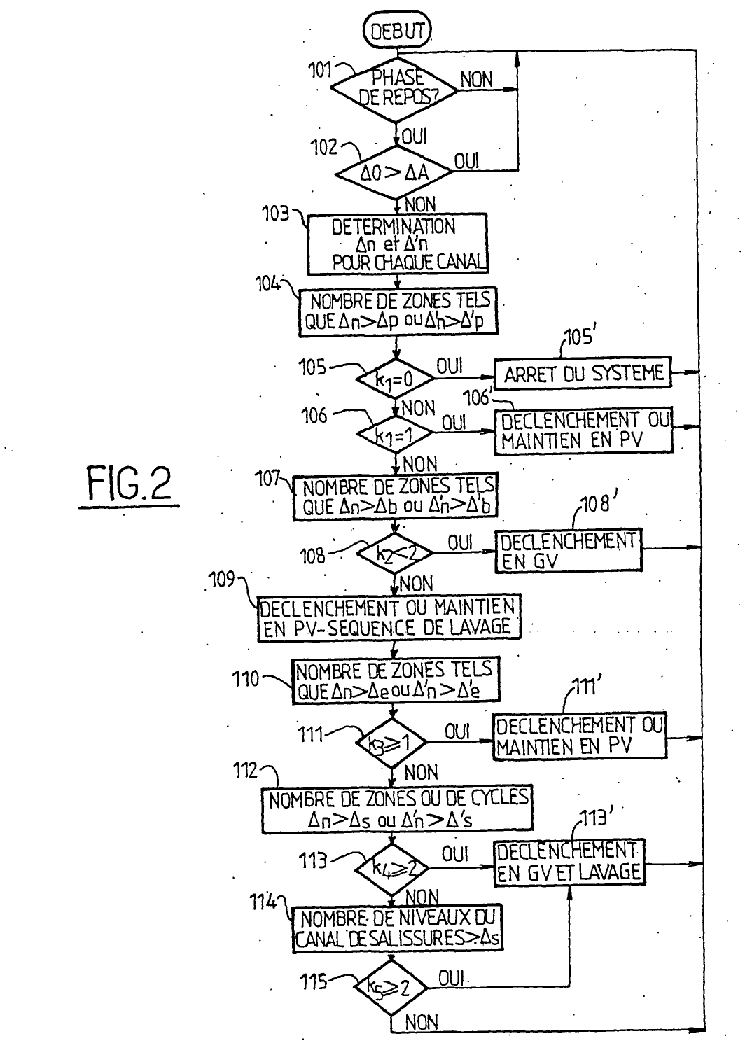

In the data processing example illustrated by the decision algorithm in FIG. 2, different cleaning speeds are activated in the following manner based on the analysis of the recordings of different conditions of stains defined by type and degree:

at step 101, detection of the current speed analysis only begins if the system is in a resting state;

at step 102, the analysis is only activated in this example if the relative level of ambient light stays lower than the ceiling value (Δ0>ΔA);

at step 104, determination of the number of zones k1 for which the spreads Δ and Δ′, determined by step 103, are greater than one of the rain thresholds, either Δp or Δp′;

at the decision step 105, if all the values Δ and Δ′ are lower than the rain thresholds Δp and Δp′ (k1=0), no stain is registered and a control stop of the blades or keeping them in a stopped position is activated at step 105′;

at the decision step 106, is a rain sensor is registered for only one zone (k1=1), the first wiper speed (small speed, abbreviated PV) is activated at step 106′;

at step 107, determination of the number of zones k2 for which the spreads Δ and Δ′ are greater than the mud thresholds Δb or Δ′b;

at decision step 108, if the stains are registered for more than one zone, made up of stains of rain and at least a mud stain for a channel (k2=1), the rain″ stain type is registered, and the second wiping speed (large speed, abbreviated GV) is activated at step 108;

at step 109, if mud stains are registered for more than zone (k2≧2), the “mud” stain type is registered, and the first wiping speed PV as well as a sequence of consecutive wash cycles, 3 cycles in the production example, are activated;

at step 110, determination of the number of zones k3 for which the spread Δ or Δ′ are greater than the thresholds for snow Δe or Δ′e;

at decision step 111, if a snow stain is registered for at least one channel (k3≧1), the “snow” stain type is registered, and the first wiping speed PV is activated or maintained (step 111′);

at step 112, determination of the number of zones k4 of the aqueous stain channel or of the number of detection cycles, for which the deviation Δ or Δ′ is greater than a opaque stain threshold value Δs or Δ's;

at decision step 113, if an opaque stain is registered on at least two zones or on at least three cycles, the “opaque” stain type is registered and the GV speed is activated, as well as a sequence of consecutive washing cycles, 5 cycles in the production example (step 113);

at step 114, recording of an opaque stain and activation of the washing cycle, when the number k5 of consecutive levels on the opaque stain channel greater than a threshold value is greater than two, for more than one wiping cycle (steps 115 and 113′).

In a variance, supplementary steps are included in the algorithm in order to determine the value of the rank m intervening in the value of the secondary difference Δ′ based on the cleaning speed or the variation of the ambient light, in order to augment the viability of the decision.

In a production model, a sample is held and recorded as long as the floating reference sample, all samples followed by samples, of which the difference of the amplitude with which the sample in question does not surpass a predetermined threshold during a determined duration. This threshold is chosen for taking into account the quantification noise of the processing organ and the determined duration taking different values according to the wiping system being stopped or in movement, for example, respectively 3 to 15 seconds and 0.2 to 0.4 seconds.

According to another production mode of the detection algorithm, the current sample values and the last recorded sample values are compared to the values of the sample values corresponding to a floating reference condition, the measures of ambient light and modulated light being produced when then wiping system is in the working phase.

In order to illustrate this production method, for wiping speeds are created:

wait or stop: immobility of the wiping system in its initial resting phase;

intermittent : periods of immobility varying with the quantity of stains to be cleaned;

small speed continuous “PV”;

large speed continuous “GV”;

The driving motor of the blades functions according to four speeds and conforms to changing functioning speed requests. These changes obey the algorithms allowing a rapid increase in speed, for example in the case of an impromptu splash, and a controlled and progressive decrease of speed, in order to assure the driving comfort of the user. The memories of the microcontroller contain base variables used in these algorithms and incremented in the following manner:

“Current functioning method”: vigorous and effective wiping speed;

“Request” functioning method: variable wiping speed for which one must apply to the motor in view of the presence of stains on the plate and requiring

“Historical”: the detections of the modulated and non-modulated light are recorded in a table, in order to create a posteriori retrospective on, for example, the last 20 wiping cycles, and avoiding the abrupt transitions judged erratic by the user; and

“Counter”: recording of the number of wiping cycles imposed in order to avoid abrupt wiping stoppages, or recording of the number of minimums, or recording of the number of channels having detected one or more stains.

The invention is not limited to the production examples described and represented above. It is possible to determine the primary and secondary spreads in relation to the lower values to short, long term or to the sample of floating reference. In order to augment the dynamics of the control, it is possible to take into account the values of the levels of interpolated amplitude corresponding to the virtual channels arranged between two real canals.

However, the geometry of the placement of the channels can vary: placement in a hexagonal pattern or in rows. The optical detectors and the photo emitting diodes can be arranged on the supports or integrated in them, for example on the supports in epoxy. In addition, the diodes and the optical detectors can be exchanged, by keeping the same sensitivity, the adaptation of the appropriate electronic processing being within the means of a tradesman.

The resting phase during which the detections are in general created, can also engulf the beginnings and ends of the cycle, which increases the number of samples measured and thus the viability of the measures.

The stopped position of the blades corresponds well to a low and horizontal position, close to the center of the body of the vehicle, which in a high position, in which the blades are vertically arranged.

In addition, the control process conforming to the invention can be adapted to activate other types of functions, for example: detection of frost in order to order heat for the windshield; detection of rain in order to automatically close an sunroof or window, specifically during the stop cycle, etc.

What is claimed is:

1. Automatic control equipment for cleaning a plate surface exhibiting varied soiled conditions, comprising at least a light source (1, 1a), an opaque stain channel, an aqueous stain channel and at least an optical detector (2, 2a) with independent photosensitive element, the source (1, 1a) and the optical detectors being arranged on a support on the side of the inner surface (10a) of the windscreen (10) to be cleaned, characterized in that the optical detectors (2, 2a) are at a distance from the source (1, 1a) based on backscatter angles (C, D) of the opaque stains and reflection (A, B) of the aqueous stains, an electronic processing unit (4) comprising a multiplexing block (3) and a microcontroller (5), is coupled in input with the optical detector channels, and in output with a control unit (6) for the wiper and windshield washer of the surface (10) to be cleaned.

2. Automatic control equipment according to claim 1, in which a supplementary optical detector (2b) is created in order to form an ambient light channel from a representative signal of ambient light, the ambient light being diffused across a transparent diffusing film (8), captured by the optical detector (2b), that applies level value of the microcontroller via amplification of the signal operated by the electronic processing unit (4).

3. Automatic control equipment according to claim 1, in which either the optically sensitive surface of each optical detector is equipped with an infrared optical filter and each source emits infrared light; or each optical detector is coupled to a pass-band filter, and each source emits a light in the passing band of the filter, in visible or infrared light.

4. Automatic control equipment according to claim 1, in which the light source (1) is a diode, that emits in the infrared or visible spectrum, and is surrounded by a guiding mask of emitted light, in which the aqueous stain optical detectors are arranged at the tops of a polygon, the center of which corresponds to the position of the emitting source (1), and the optical detectors and the emitting source(s) are linked to a support placed across from the internal surface of the plate to be surveyed.

5. Control process for cleaning a plate surface, specifically a motor vehicle window, via dynamic optical detection of its condition, the plate have a width limited by the surface to be cleaned and an internal surface, in which at least one modulated light flux is emitted across the width of the plate then backscattered and/or back-reflected by the surface to be cleaned, the light intensity of the modulated light being then measured in several elementary zones under the form of amplitude levels of signals successively transmitted across the opaque and aqueous stain recording channels via the use of the equipment according to one of the previous claims, in which the level of each detection zone of each channel, as well as that of the ambient light, are successively cumulated in a given time interval in order to form samples to record, and in which, in a detection algorithm, the relative spreads between, first, the current sample values of the each detection of each channel and, secondly, the sample values of each detection recorded in the short term, and respectively at least a floating reference, able to be lower values, are determined in relation to the values of the current samples in order to form, respectively two different deviations, at least one of these deviations being compared to at least a predetermined threshold and a cleaning speed adapted to the number, to the type of stain, and to the duration of the detections for which the deviations are greater than the predetermined threshold values, being thus required.

6. Control process for cleaning according to claim 5, in which a level of ambient light being produced and recorded at the same speed as that of the measures of the levels of modulated light of each channel, the results of the comparisons of the absolute values of the relative spreads of modulated light are not taken into account if the variation of the level of ambient light at the same moment is lower than a determined threshold, the measure of the level of ambient light validating the current detection signals and thus the observed deviations.

7. Control process for cleaning according to claim 5 or 6, in which, the aqueous stain detection is based on the functioning condition of the wipers:
when the wipers are resting, the detection is recorded if the detected level in the channel surpasses the reference value of a value greater than a predetermined threshold;
when the wipers function, the detection is taking into account at the end of a working interval if the minimum number concerning the cleaning period is greater than two;

8. Control process for cleaning according to claim 5, in which the opaque stain detection accessible from:
the aqueous stain channel, if the detection level is greater than the reference value surpassing a predetermined threshold value, when such a spread is less than a predetermined number of detection cycles or for a predetermined number of detections; or
the opaque stain channel, when the level is great than a predetermined threshold value, stains accumulate slowly being more specifically detected by the channel; in order to avoid a useless cleaning, for example in the case of snowfall, it verifies that the stain stays after at least one pass of the wipers.
